(19) United States
(12) Patent Application Publication
(10) Pub. No.: US 2018/0260110 A1
(43) Pub. Date: Sep. 13, 2018

(54) VIRTUAL KEYBOARD SYSTEM AND METHOD OF OPERATION FOR THE SAME

(71) Applicant: CHENG TUNG HSU, TAIPEI (TW)

(72) Inventor: CHENG TUNG HSU, TAIPEI (TW)

(21) Appl. No.: 15/453,840

(22) Filed: Mar. 8, 2017

(51) Int. Cl. G06F 3/0488; G06F 3/023; G06F 3/041

(52) U.S. Cl. CPC G06F 3/04886; G06F 3/041; G06F 3/04883; G06F 3/0233

(57) ABSTRACT

The present invention relates to a virtual keyboard system and a method thereof for retrieving stored text blocks, thereby activating a text block storage process.

### FIELD OF THE INVENTION

The invention relates, generally, to keyboard systems for providing input to touch screen based computer operating systems. More particularly, the present invention relates to a virtual keyboard system applied to a touch screen operated electronic device for retrieving stored text blocks and a method of operation for the same, thereby activating a text block storage process.

### BACKGROUND OF THE INVENTION

Physical keyboards are the most ubiquitous input devices for users to enter data and commands into computers. Typing is a widely known and commonly practiced skill. When digital computing became a reality, physical keyboards having the standard typewriter key layout (commonly known as the “QWERTY” key layout) naturally became the standard input means for a user to enter data into a computer.

As much smaller computing devices and intelligent cell phones enter the market, there arises a need for a smaller and on-demand type of keyboard. A virtual keyboard is essentially a replica of a real keyboard (or portion thereof) that is presented on a touch screen. To enter a character, a user touches the touch screen in a location for the character they desire to input. Thus, a user can use a virtual keyboard to enter text into a data field at a computer system.

A “virtual” or “soft” keyboard is a keyboard depicted on a touch screen and the keystrokes or hits are registered by a touch detecting function. It is not a hardware keyboard, which is located external to the touch screen. A virtual keyboard is a software component that allows a user to enter characters. Also it can be called up for use on demand. When inputting is not needed in an application of the computer or phone device the Virtual Keyboard app is not called up. Thus it does not take up the precious screen space of that device when it is not in use.

Virtual keyboards are used in many mobile devices. Many of the current mobile devices use a virtual keyboard having a touch screen to enter characters. Virtual keyboards are commonly used as an on-screen input method in devices with no physical keyboard, where there is no room for one, such as a pocket computer, personal digital assistant (PDA), tablet computer or touch screen equipped mobile phone. It is common for the user to input text by tapping a virtual keyboard built into the operating system of the device. In common practice, virtual keyboard exists not only as a built in system function of the devices. It is developed into hundreds of software applications available for users to choose from. They work based on the same principle of operation, yet each with its own look and feel. Some of them enhanced the functionality of inputting character by character and add dictionary and phrases for user to pick while inputting. A typical such software application is G board of Google. It incorporated both dictionary and phrases in its input operation.

Virtual keyboards have been proposed to detect text inputs. For example, U.S. Pat. No. 7,215,327 issued to Liu et al. entitled “Device and Method for Generating a Virtual Keyboard/Display,” utilizes two scanning lasers to scan a working surface to determine locations and movements of a user's fingers. The device determines the finger's locations by comparing a time difference received from the two reflected scanning lasers.

For touch screen based computer operating system, such as Android or IOS (of Apple's iphones and ipads), there are at least 6 ways to convey different commands that users can activate about a designated screen area, such as a key button on virtual keyboard applications. The 6 ways are Light Touch, Long Press, Swipe Up, Swipe Down, Swipe Left and Swipe Right. Let us call those ways of command to convey user intension ‘action’ to facilitate later discussion.

The typical virtual keyboard applications in the market use only one or two actions in their software to allow user to designate whether he/she wants to indicate whether a main alphabet/number/symbol is to be selected, or an alternative one is selected for text input.

Normally adding entries to either dictionary or phrases are done through another operation, not in the inputting process itself. It is safe to say that trying to command the virtual keyboard application to input more than one character a time has been slow, time consuming, non-intuitive in currently available commercial virtual keyboard applications.

Therefore there exists a hidden need for a much more versatile added feature in virtual keyboard applications that would allow user to add words, phrases, paragraphs, even articles of thousands of words for easy retrieval and use it as the input text. In other words, there exists a vacuum in the market for an easy to use text storage and retrieval system in the virtual keyboard application.

### OBJECTIVE OF THE INVENTION

The principle objective of the present invention is to overcome the limitations of the prior art and provide a new functionality of an easy to use text block storage and retrieval system, to be used as the input text which user can type into any document that he/she is editing.

An objective of the present invention is to provide a virtual keyboard system having a plurality of keys, applied to a touch screen operated electronic device for retrieving stored text blocks, and a method of operation for the same.

Another objective of the present invention is to provide a virtual keyboard system that is operational in phones/pads/computers that uses touch screens, such as all the Android phones/pads and Apple's iphones and ipads.

Another objective of the present invention is to provide a virtual keyboard system which can be customized in correspondence with the needs of users, and allows flexible data inputs for respective input items.

Another objective of the present invention is to provide user the ability to store and retrieve any number of stored text blocks, each of any length, with minimum efforts and convenient recalling using the virtual keyboard system.

Yet another objective of the present invention is to provide a virtual keyboard application, wherein at least three actions are added for storage, viewing and retrieval of the text data.

Yet another objective of the present invention is to provide a virtual keyboard system having a plurality of keys that are a combination of numerals, alphabets and special characters.

These and other objectives of the present invention will be apparent from the drawings and descriptions herein. Every objective of the invention is attained by at least one embodiment of the invention. However, no embodiment necessarily meets every objective set forth herein.

### SUMMARY OF THE INVENTION

The present invention envisions a virtual keyboard system, applied to a touch screen operated electronic device for retrieving stored text blocks and a method of operation for the same using actions (actions), thereby activating a text block storage process.

According to an embodiment of the present invention, the virtual keyboard system for an electronic device, comprises of;
plurality of keys for inputting characters and a plurality of patterns on said keys;
at least one processor associated to said electronic device;
a memory segment, storing the entered input characters; and
at least three command actions applied on a predefined screen area of said virtual keyboard system, wherein a first action (such as Long Press) allows storage of data text in plurality of cells using an index key; a second action (such as Light Touch) allows retrieval of said stored text and provides an output to a text editor to complete the input phase of said text; and a third action (Swipe Up or Swipe Down) allows viewing of said stored text block by way of a temporary floating window showing the text.

According to another embodiment of the present invention, the keyboard layout is activated by a specially assigned action (such as Long Press) so that subsequently user can use the three actions to store, view and retrieve stored text block or data.

According to an embodiment of the present invention, the method of operation or functioning of virtual keyboard system, applied to a touch screen operated electronic device, comprising the steps of;
selecting at least one character (symbol/alphabet) using plurality of keys associated to said keyboard system;
generating a keyboard layout consisting of plurality of storage cells thereby forming a storage cells system by a specially designated action, such as Long Press;
storing data text of predetermined size in a plurality of storage cells of said keyboard layout with a first command action (such as Long Press);
retrieving stored text and providing an output to a text editor to complete the input phase of said text with a second command action (such as Light-Touch); and
viewing said stored text using a third command action (such as Swipe Up or Swipe Down).

According to another embodiment of the present invention, the system is applied to any language that uses alphabets for inputting.

The above and other features and advantages of the invention will become more readily apparent from the following detailed description taken with the following drawings.

### BRIEF DESCRIPTION OF THE DRAWINGS

These and other features, aspects, and advantages of the present invention will become better understood with regard to the following description, appended claims, and accompanying drawings where:

FIG. 1 illustrates the layout of the virtual keyboard system.

FIG. 2 illustrates the keyboard layout with stored text according to an embodiment of the present invention.

### DETAILED DESCRIPTION OF THE INVENTION

The following description includes the preferred best mode of one embodiment of the present invention. It will be clear from this description of the invention that the invention is not limited to these illustrated embodiments but that the invention also includes a variety of modifications and embodiments thereto. Therefore the present description should be seen as illustrative and not limiting. While the invention is susceptible to various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims.

In any embodiment described herein, the open-ended terms “comprising,” “comprises,” and the like (which are synonymous with “including,” “having” and “characterized by”) may be replaced by the respective partially closed phrases “consisting essentially of,” consists essentially of,” and the like or the respective closed phrases “consisting of,” “consists of, the like.

As used herein, the singular forms “a,” “an,” and “the” designate both the singular and the plural, unless expressly stated to designate the singular only.

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In addition, reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the drawings, identical reference numbers identify similar features or elements. The size and relative positions of features in the drawings are not necessarily drawn to scale. For example, the shapes of various features are not drawn to scale, and some of these features are enlarged and positioned to improve drawing legibility.

Various embodiments of the invention may be implemented in one or any combination of hardware, firmware, and software. The invention may be implemented as instructions contained in or on a computer-readable medium, which may be read and executed by one or more processors to enable performance of the operations described herein. A computer-readable medium may include any mechanism for storing information in a form readable by one or more computers. For example, a computer-readable medium may include a tangible storage medium, such as but not limited to read only memory (ROM); random access memory (RAM); magnetic disk storage media; optical storage media; a flash memory device, etc.

Various embodiments of the invention relate to a configuration of virtual keys that belong to a virtual keyboard displayed on a touch-screen. Rather than being arranged in straight horizontal rows, the keys may be arranged in arcs that are conveniently reached by the user's thumb(s) when the device is held in the user's hand(s). The present invention envisions a virtual keyboard system, applied to a touch screen operated electronic device for retrieving stored text blocks and a method of operation for the same, thereby activating a text block storage process.

The core of this invention involves utilizing the ‘softness’ of the virtual keyboard—meaning that the keyboard design can change in the inputting process. That is the ultimate benefit of a software based keyboard.

Instead of merely inputting what is shown on the key tops (usually one symbol/character/number as primary input text and another symbol/character/number as secondary input text. Almost all virtual keyboard software application works this way.

The keyboard layout of the instant invention is activated as a first step in using the three command actions; to store, view and retrieve stored text block or data. The storage cell keyboard layout must first be activated to allow subsequent 3 actions (store, view, output) to take place after said activation. The storage cell page is invoked when user typed a few alphabet/number/symbols, with the last key Long Press as activator. The system uses the user typed as ‘the reference key’ of the storage page.

For example a user typed ‘passw1’ with the last ‘1’ long pressed. Then a storage page will appear with 40 or so storage cell ready to use. And this ‘passw1’ will need to be remembered by the user to access the stored text data. The data stored can be used, wherein the user can click on the stored text and get it typed into the underlying application (normally an editor or a message editor). Therefore when user click on a particular cell, the user accomplish the basic text input. There is no limit to the size of text. Even text of hundreds of thousands of words can be stored and typed into an editor this way. The user can also inspect the text data without typing the text data into the underlying application by using the View action.

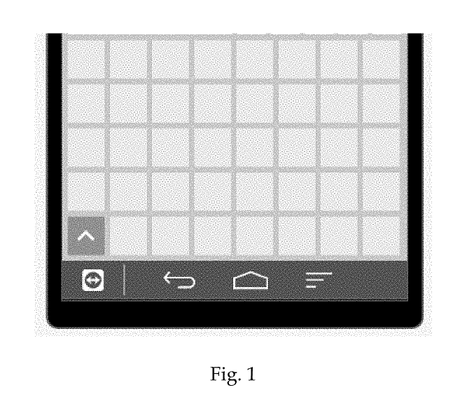

Referring to FIG. 1, illustrates the virtual keyboard system for an electronic device, comprises of plurality of keys for inputting characters and a plurality of patterns on said keys; at least one processor associated to said electronic device; a memory segment, storing the entered input characters; and at least three command actions applied on a predefined screen area of said virtual keyboard system, wherein a first command action (such as Long Press) allows storage of data text in plurality of cells using an index key; a command second action (such as light touch) allows retrieval of said stored text and provides an output to a text editor to complete the input phase of said text; and a third command action (Swipe Up or Swipe Down) allows viewing of said stored text block.

The virtual keyboard system is operational in phones/pads/computers that uses touch screens, such as all the Android phones/pads and Apple's iphones and ipads.

The virtual keyboard system which can be customized in correspondence with the needs of users and allows flexible data inputs for respective input items. The system provides the user to store and retrieve any number of stored text blocks, each of any length, with minimum efforts and maximum recalling using the virtual keyboard system.

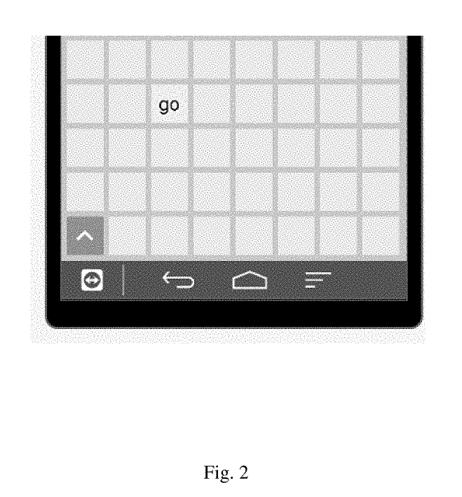

Referring to FIG. 2, illustrates an embodiment of the virtual keyboard system for an electronic device with stored cells and text. The method of operation or functioning of virtual keyboard system, applied to a touch screen operated electronic device, comprising the steps of; selecting at least one character (symbol/alphabet/number) using plurality of keys associated to said keyboard system; generating a keyboard layout consisting of plurality of storage cells thereby forming a storage cells system; storing data text of predetermined size in a plurality of storage cells of said keyboard layout with a first action retrieving stored text and providing an output to a text editor to complete the input phase of said text with a second action (Long Press) and; viewing said stored text using a third action (Swipe Up or Swipe Down).

The user can also change the content of system clipboard and use Long Press again to replace the content of the storage cell.

Various embodiments mention of storage and retrieval of text in a similar manner as per the present invention. Example is, class mate names, say under key value ‘class91’ for high school classmate names and ‘class94’ for college classmate names; product names, say under key value ‘item’ for all the major items that one is selling or buying; diary type of text under key value ‘20140715’ for diary text of that particular date. User can thus easily keep memo for his/her activity of each day. There is no need to run a separate diary application. Simply type a date as key (with the last character/number/alphabet/symbol using the activation action) and store important things inside its many storage cells.

Thus, this written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A virtual keyboard system for an electronic device, comprising;
plurality of keys for inputting characters and a plurality of patterns on said keys;
at least one processor associated to said electronic device;
a memory segment, storing the entered input characters; and
at least three command actions applied on a predefined screen area of said virtual keyboard system, wherein a first command action (such as Long Press) allows storage of data text into one of a plurality of cells using an index key; a second command action (such as Light Touch) allows retrieval of said stored text and provides an output to a text editor to complete the input phase of said text; and a third command action (Swipe Up or Swipe Down) allows viewing of said stored text block.

2. An improved virtual keyboard system, applied to a touch screen operated electronic device as claimed in claim 1, wherein said system is operational in phones/pads/computers that uses touch screens, such as all the Android phones/pads and Apple's iphones and ipads.

3. An improved virtual keyboard system, applied to a touch screen operated electronic device as claimed in claim 1, wherein said system functions on any keyboard and supports alphabets of any type of language (Latin, Arabic, Greek, Latin, Hebrew . . . ).

4. A method of operation or functioning of virtual keyboard system as claimed in previous claims applied to a touch screen operated electronic device, comprises the steps of;
selecting at least one character (symbol/alphabet) using plurality of keys associated to said keyboard system;
generating a keyboard layout consisting of plurality of storage cells thereby forming a storage cells system with a specially designate action;
storing data text of predetermined size in a plurality of storage cells of said keyboard layout with a first action;
retrieving stored text and providing an output to a text editor to complete the input phase of said text with a second action (long press);
viewing said stored text using a third action (Swipe Up or Swipe Down)

5. A method of operation or functioning of virtual keyboard system as claimed in claim 4, wherein a user can change the content of system clipboard by using the Long Press to replace the content of the storage cell.
